(19) United States
(12) Patent Application Publication
(10) Pub. No.: US 2008/0174721 A1
(43) Pub. Date: Jul. 24, 2008

(54) Liquid crystal panel with color filter substrate having OLED units and liquid crystal display with same

(75) Inventor: Wei Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.; INNOLUX DISPLAY CORP.

(21) Appl. No.: 12/011,170

(22) Filed: Jan. 23, 2008

(30) Foreign Application Priority Data
Jan. 24, 2007 (CN) 200710073109.8

(51) Int. Cl. G02F 1/13357

(52) U.S. Cl. 349/69

(57) ABSTRACT

An exemplary liquid crystal panel includes a first substrate, a second substrate parallel to the first substrate, and a liquid crystal layer between the first substrate and the second substrate. The second substrate includes color units and OLED units provided at substantially a same layer thereat, and the OLED units and the color units are alternately arranged. An LCD including the liquid crystal panel is also provided.

### FIELD OF THE INVENTION

The present invention relates to a liquid crystal panel that includes a plurality of organic light emitting display (OLED) units provided at a color filter substrate thereof, and a liquid crystal display (LCD) including the liquid crystal panel.

### GENERAL BACKGROUND

Recently, LCDs that are light and thin and have low power consumption characteristics have been widely used in office automation equipment, video units, and the like.

Referring to FIG. 3, a typical transmissive liquid crystal panel 1 includes a color filter substrate 11, a thin film transistor (TFT) substrate 12 parallel to the color filter substrate 11, and a liquid crystal layer 13 sandwiched between the two substrates 11, 12.

A plurality of pixel electrodes (not shown) are formed at an inner surface (not labeled) of the TFT substrate 12, generally opposite to the color filter substrate 11. The color filter substrate 11 includes a plurality of color units 152, black matrix units 153, and a transparent conductive layer (not labeled) formed thereat. The color units 152 and the black matrix units 153 are respectively formed at an inner surface (not labeled) of the color filter substrate 11, which inner surface is generally opposite to the TFT substrate 12. The color units 152 respectively correspond to the pixel electrodes of the TFT substrate 12. Each color unit 152 is separated from its neighboring color units 152 by the black matrix units 153, in order to avoid color mixing.

In operation of the transmissive liquid crystal panel 1, light beams pass through the TFT substrate 12 and the liquid crystal layer 13, and reach the color units 152 and the black matrix units 153 of the color filter substrate 11. The light beams reaching the black matrix units 153 are absorbed by the black matrix units 153. The light beams reaching the color units 152 emit from the color filter substrate 11 after being filtered by the color units 152. Many light beams are absorbed by the black matrix units 153, and the brightness of the light beams filtered by the color units 152 is also reduced. Overall, the brightness of the light beams emitting from the color filter substrate 11 may be significantly low, particularly when the transmissive liquid crystal panel 1 is controlled to display white images. Thus, a contrast of the transmissive liquid crystal panel 1 is low, and an optical performance of a transmissive LCD (not shown) employing the transmissive liquid crystal panel 1 is correspondingly low.

What is needed, therefore, is a liquid crystal panel that can circumvent, overcome or at least mitigate the above-described difficulties. What is also needed is an LCD including the liquid crystal panel.

### SUMMARY OF THE INVENTION

In an exemplary embodiment, a liquid crystal panel includes a first substrate, a second substrate parallel to the first substrate, and a liquid crystal layer between the first substrate and the second substrate. The second substrate includes color units and OLED units provided at substantially a same layer thereat, and the OLED units and the color units are alternately arranged. An LCD including the liquid crystal panel is also provided.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a side cross-sectional view of part of an LCD according to an exemplary embodiment of the present invention, the LCD including a liquid crystal panel that has a color filter substrate and a plurality of OLED units on the color filter substrate.

FIG. 2 is essentially an enlarged, side cross-sectional view of one of the OLED units on the color filter substrate of FIG. 1.

FIG. 3 is a side cross-sectional view of part of a conventional liquid crystal panel.

### DETAILED DESCRIPTION OF PREFERRED EMBODIMENTS

Reference will now be made to the drawings to describe various embodiments of the present invention in detail.

Referring to FIG. 1, an LCD 200 according to an exemplary embodiment of the present invention is shown. The LCD 200 includes a liquid crystal panel 220, and a backlight module 210 for providing light beams to the liquid crystal panel 220.

The liquid crystal panel 220 is a transmissive liquid crystal panel, and includes a TFT substrate 230, a color filter substrate 240 parallel to the TFT substrate 230, and a liquid crystal layer 254 sandwiched between the two substrates 230, 240. A plurality of TFTs 255 and pixel electrodes 256 are alternately formed at an inner surface (not labeled) of the TFT substrate 230, generally opposite to the color filter substrate 240.

The color filter substrate 240 includes a plurality of OLED units 2510, a plurality of dielectric units 2511, a plurality of color units 2521, and a transparent conductive layer 253. The OLED units 2510 and the color units 2521 are alternately formed at an inner surface (not labeled) of the color filter substrate 240, generally opposite to the TFT substrate 230. The color units 2521 include a plurality of different-colored color units. Each of the color units 2521 is spaced from its neighboring color units 2521 by the OLED units 2510, in order to avoid color mixing. In the illustrated embodiment, the color units 2521 includes a plurality of red, green, and blue (RGB) color units, and can filter light beams passing therethrough. The OLED units 2510 are respectively covered by the dielectric units 2511. The color units 2521 and the dielectric units 2511 are covered by the transparent conductive layer 253. The transparent conductive layer 253 is generally made of transparent material, such as indium tin oxide (ITO) or indium zinc oxide (IZO). The dielectric units 2511 are preferably made from insulation materials.

One OLED unit 2510 covered by the corresponding dielectric unit 2511, one TFT 255 corresponding to the OLED unit 2510, and liquid crystal molecules of the liquid crystal layer 254 between the OLED unit 2510 and the TFT 255 cooperatively define an OLED region 251. One color unit 2521, one pixel electrode 256 corresponding to the color unit 2521, and liquid crystal molecules of the liquid crystal layer 254 between the color unit 2521 and the pixel electrode 256 cooperatively define an LCD region 252. One OLED region 251 and one adjacent LCD region 252 cooperatively define a pixel region 250. That is, the liquid crystal panel 220 can be considered to include a plurality of pixel regions 250, each including an OLED region 251 and an LCD region 252.

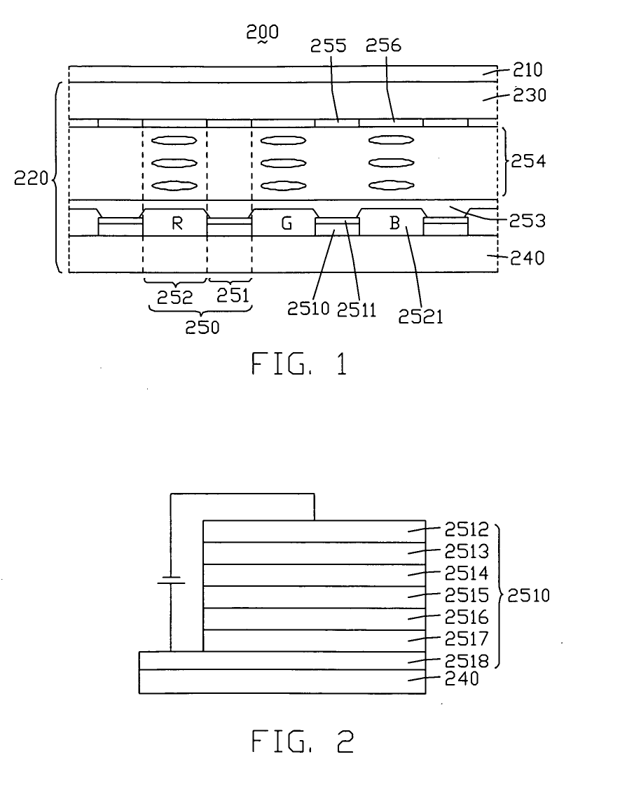

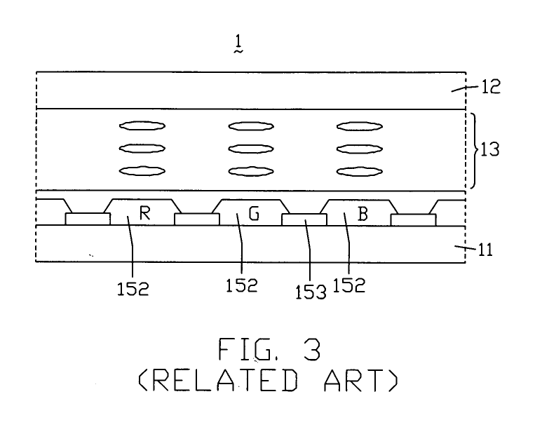

Referring also to FIG. 2, each OLED unit 2510 includes a metallic anode layer 2518, a hole injection layer (HIL) 2517, a hole transfer layer (HTL) 2516, an organic emission layer 2515, an electron transfer layer (ETL) 2514, an electron injection layer (EIL) 2513, and a metallic cathode layer 2512, arranged in that order from bottom to top. The metallic anode layer 2518 is formed on the inner surface of the color filter substrate 240. The dielectric unit 2511 covers the respective metallic cathode layer 2512 of the OLED unit 2510, and helps to smooth the metallic cathode layer 2512. When the metallic anode layer 2518 and the metallic cathode layer 2512 have a potential applied thereto, the OLED unit 2510 responds to the potential by emitting light beams.

In operation of the LCD 200, the backlight module 210 functions as a planar light source. Light beams emit from the backlight module 210 and reach the liquid crystal panel 220. The light beams pass through the TFT substrate 230 and the liquid crystal layer 254, and reach the color units 2521 and the OLED units 2510 covered by the dielectric units 2511. When one pixel region 250 is controlled to display a darkest gray level, the OLED unit 2510 of the pixel region 250 acts as a conventional black matrix unit. That is, the light beams reaching the OLED unit 2510 of the pixel region 250 are absorbed by the OLED unit 2510. The light beams reaching the color unit 2521 of the pixel region 250 are filtered thereby, and emit from the color filter substrate 240 with the particular color of the color unit 2521. When the pixel region 250 is controlled to display a brightest gray level, the OLED unit 2510 of the pixel region 250 acts as a light beam provider. That is, the metallic anode layer 2518 and the metallic cathode layer 2512 of the OLED unit 2510 have a controllable potential applied thereto, and the OLED unit 2510 responds to the potential by emitting white light beams with a maximum brightness. Therefore, a brightness of the light beams emitting from said pixel region 250 is improved. When the pixel region 250 is controlled to display another gray level between the darkest gray level and the brightest gray level, the potential applied to the metallic anode layer 2518 and the metallic cathode layer 2512 of the OLED unit 2510 is suitably controlled to provide white light beams with the desired brightness. The other pixel regions 250 of the liquid crystal panel 220 function similarly to said pixel region 250. The above-described operations can be realized with a driving circuit (not shown) provided for driving the liquid crystal panel 220.

In summary, the OLED units 2510 of the liquid crystal panel 220 not only take the place of conventional black matrix units to separate the color units 2521 and absorb incident light beams, but also provide white light beams with controllable brightness for the liquid crystal panel 220. In addition, the LCD 200 can attain an optimal display effect by configuring an area ratio of the OLED region 251 and the LCD region 252 according to particular display and optical requirements. In the exemplary embodiment, the area ratio of the OLED region 251 to the corresponding pixel region 250 is configured to be in the range from 10% to 90%. Thus the liquid crystal panel 220 can achieve a high luminance and a high contrast by the utilization of the OLED units 2510, and an optical performance of the LCD 200 is correspondingly improved.

In alternative embodiments, the liquid crystal panel 220 can be a transflective liquid crystal panel or a reflective liquid crystal panel. In each such case, the OLED units 2510 are suitably configured to function in the transflective liquid crystal display or the reflective liquid crystal display.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel comprising:
a first substrate;
a second substrate parallel to the first substrate, the second substrate comprising a plurality of color units and organic light emitting display (OLED) units provided at substantially a same layer thereat, the OLED units and the color units being alternately arranged; and
a liquid crystal layer between the first substrate and the second substrate.

2. The liquid crystal panel as claimed in claim 1, wherein the first substrate is a thin film transistor (TFT) substrate, which comprises a plurality of TFTs and pixel electrodes provided at an inner surface thereof.

3. The liquid crystal panel as claimed in claim 2, wherein one OLED unit, one TFT corresponding to the OLED unit, and liquid crystal molecules of the liquid crystal layer between the OLED unit and the TFT cooperatively define an OLED region.

4. The liquid crystal panel as claimed in claim 3, wherein one color unit, one pixel electrode corresponding to the color unit, and liquid crystal molecules of the liquid crystal layer between the color unit and the pixel electrode cooperatively define a liquid crystal display (LCD) region.

5. The liquid crystal panel as claimed in claim 4, wherein one OLED region and one adjacent LCD region cooperatively define a pixel region.

6. The liquid crystal panel as claimed in claim 5, wherein an area ratio of the OLED region to the pixel region is configured to be in the range from 10% to 90%.

7. The liquid crystal panel as claimed in claim 5, wherein an area ratio of the LCD region to the pixel region is configured to be in the range from 10% to 90%.

8. The liquid crystal panel as claimed in claim 5, wherein the OLED units are configured to provide white light beams with controllable brightness for display by the liquid crystal panel.

9. The liquid crystal panel as claimed in claim 8, wherein no light beams are provided by the OLED unit of the pixel region when the pixel region is controlled to display a darkest gray level.

10. The liquid crystal panel as claimed in claim 8, wherein the OLED unit of the pixel region provides white light beams with a maximum brightness when the pixel region is controlled to display a brightest gray level.

11. The liquid crystal panel as claimed in claim 1, wherein the second substrate is a color filter substrate, and comprises an inner surface, and each OLED unit comprises an anode layer, a hole injection layer, a hole transfer layer, an organic emission layer, an electron transfer layer, an electron injection layer, and a cathode layer, which are arranged in that order from the inner surface toward the liquid crystal layer, with the anode layer provided at the inner surface.

12. The liquid crystal panel as claimed in claim 11, wherein the second substrate further comprises a plurality of dielectric units respectively covering the cathode layers of the OLED units.

13. The liquid crystal panel as claimed in claim 12, wherein the dielectric units are made from insulation material.

14. The liquid crystal panel as claimed in claim 12, wherein the second substrate further comprises a transparent conductive layer covering the color units and the dielectric units.

15. The liquid crystal panel as claimed in claim 1, wherein the liquid crystal panel is one of a transmissive liquid crystal panel, a reflective liquid crystal panel, and a transflective liquid crystal panel.

16. The liquid crystal panel as claimed in claim 1, wherein the OLED units are configured for absorbing light incident thereon.

17. A liquid crystal panel comprising:
a first substrate;
a second substrate parallel to the first substrate, the second substrate comprising:
a plurality of color units configured for filtering light beams passing therethrough; and
a plurality of organic light emitting display (OLED) units each separating at least two neighboring color units, the OLED units being configured for absorbing light incident thereon and providing light beams with controllable brightness for display by the liquid crystal panel; and
a liquid crystal layer between the first substrate and the second substrate.

18. A liquid crystal display comprising:
a liquid crystal panel comprising:
a first substrate;
a second substrate parallel to the first substrate, the second substrate comprising a plurality of color units and organic light emitting display (OLED) units provided thereat, the OLED units being arranged between the color units;
a liquid crystal layer between the first substrate and the second substrate; and
a planar light source positioned for providing light beams to the liquid crystal panel.

19. The liquid crystal display as claimed in claim 18, wherein the OLED units are configured for absorbing light incident thereon.

20. The liquid crystal display as claimed in claim 18, wherein the OLED units are configured for providing white light beams with controllable brightness for display by the liquid crystal display.
